(19) United States
(12) Patent Application Publication
(10) Pub. No.: US 2025/0132101 A1
(43) Pub. Date: Apr. 24, 2025

(54) LASER-EXCISED PRINT-TO-SHAPE CAPACITOR ELECTRODE

(71) Applicant: Cardiac Pacemakers, Inc., St. Paul, MN (US)

(72) Inventors: Matthew Anderson, Coon Rapids, MN (US); Chad Allen Schindler, Ramsey, MN (US); Brian V. Waytashek, Lino Lakes, MN (US); Piotr Waszczuk, St. Paul, MN (US)

(21) Appl. No.: 18/916,180

(22) Filed: Oct. 15, 2024

Related U.S. Application Data
(60) Provisional application No. 63/544,863, filed on Oct. 19, 2023.

(51) Int. Cl. H01G 9/052; H01G 9/00; H01G 9/06

(52) U.S. Cl. CPC H01G 9/052; H01G 9/0029; H01G 9/06

(57) ABSTRACT

A method of constructing a capacitor can include forming a sintered electrode by sintering electrode material onto a portion of a first side of a substrate; and excising the sintered portion from the substrate by cutting through the substrate around a periphery of the sintered portion, without cutting the sintered portion, wherein excising includes using a femtosecond laser to cut through the substrate.

### CLAIM OF PRIORITY

This application claims the benefit of U.S. Provisional Application No. 63/544,863, filed on Oct. 19, 2023, which is hereby incorporated by reference in its entirety.

### TECHNICAL FIELD

This document relates generally to energy storage and particularly to sintered electrodes to store energy in an implantable medical device.

### BACKGROUND

Electrical stimulation therapy has been found to benefit some patients. For example, some patients suffer from an irregular heartbeat or arrhythmia and may benefit from application of electrical stimulation to the heart. Implantable medical devices can include electronics to deliver therapy to the heart.

Some medical devices utilize aluminum electrolytic high voltage capacitors to provide energy for arrhythmia therapy. For example, sintered aluminum anode electrode technology can be utilized for its high specific surface area, low resistance, and long term performance stability. Anodes, cathodes, and separators can be stacked in an alternating pattern to produce the electrode stack, which is ultimately placed into a capacitor case and filled with electrolyte.

### SUMMARY

In example 1, a method of constructing a capacitor can include forming a sintered electrode by sintering electrode material onto a portion of a first side of a substrate; and excising the sintered portion from the substrate by cutting through the substrate around a periphery of the sintered portion, without cutting the sintered portion, wherein excising includes using a femtosecond laser to cut through the substrate.

In example 2, the subject matter of example 1 can optionally include the substrate being an aluminum foil substrate about 25-35 micrometers (μm) thick.

In example 3, the subject matter of any of examples 1 or 2 can optionally include the femtosecond laser including settings wherein a pulse duration is between 222-500 femtoseconds, a frequency is between 250-500 kHz, and a power density is between 5.74×10^5 W/cm2-5.74×10^6 W/cm2.

In example 4, the subject matter of any of examples 1-3 can optionally include the femtosecond laser settings further including wherein a scan rate is between 200-2000 mm/sec, a spot overlap is between 40%-90%, and a number of passes is at least 25 passes.

In example 5, the subject matter of any of examples 1-4 can optionally include vision system used to control the femtosecond laser path during the cutting process.

In example 6, the subject matter of any of examples 1-5 can optionally include forming the sintered electrode by printing the sintered material onto the substrate into a final capacitor shape form-factor.

In example 7, the subject matter of any of examples 1-6 can optionally include the electrode material being printed on both a first side and a second side of the substrate.

In example 8, the subject matter of any of examples 1-7 can optionally include the sintered material being deposited in multiple layers having progressively smaller profiles such that a cross-section profile of the sintered material includes a tapered end.

In example 9, the subject matter of any of claims 1-8 can optionally include stacking a separator onto the first electrode; stacking a second electrode onto the separator; disposing the first electrode, the separator, and the second electrode into a capacitor case; electrically coupling the first electrode to a first terminal disposed on an exterior of the capacitor case; electrically coupling the second electrode to a second terminal disposed on the exterior of the capacitor case, the second terminal electrically isolated from the first terminal; filling the capacitor case with an electrolyte; and sealing the electrolyte in the capacitor case.

In example 10, the subject matter of any of examples 1-9 can optionally include forming multiple electrodes on the substrate, wherein each of the multiple electrodes are then cut out of the substrate separately.

Example 11 can include a capacitor including a capacitor case sealed to retain electrolyte; a sintered anode, wherein the sintered anode includes a sintered material on both sides of a substrate and wherein an edge of the sintered material on both sides of the substrate has a tapered shape in a cross-sectional profile; a cathode disposed in the capacitor case; a separator between the sintered anode and the cathode; a conductor coupled to the sintered anode, the conductor coupled to a terminal sealingly extending through and disposed on an exterior of the capacitor case; and a second terminal disposed on the exterior of the capacitor case and in electrical communication with the cathode, with the terminal and the second terminal electrically isolated from one another.

In Example 12, the subject matter of any one or more of Examples 1-11 can optionally include the capacitor case having a same shape as a shape of the anode and the cathode.

In Example 13, the subject matter of any one or more of Examples 1-12 can optionally include a plurality of sintered anodes formed in a stack with at least one of the sintered anodes having a smaller shape than other of the plurality of a sintered anodes so a side view profile of the stack matches a curve in the capacitor case.

In Example 14, the subject matter of any one or more of Examples 1-13 can optionally include the tapered shape of each of the sintered material defining a V-shape defined by the sintered material on both sides of the substrate.

In Example 15, the subject matter of any one or more of Examples 1-14 can optionally include the cathodes including sintered cathodes.

Example 16 can include a capacitor including a sintered anode formed by sintering material onto a portion of a side of an aluminum substrate and excising the sintered portion from the substrate by cutting through the aluminum substrate around a periphery of the sintered portion, without cutting the sintered portion, wherein excising includes using a femtosecond laser to cut through the aluminum substrate; stacking a separator onto the sintered anode; stacking a cathode onto the separator; disposing the anode, the separator, the cathode into a capacitor case; electrically coupling the anode to a first terminal disposed on an exterior of the capacitor case; electrically coupling the cathode to a second terminal disposed on the exterior of the capacitor case, the second terminal electrically isolated from the first terminal; filling the capacitor case with an electrolyte; and sealing the electrolyte in the capacitor case.

In Example 17, the subject matter of any one or more of Examples 1-16 can optionally include the aluminum substrate being about 25-35 micrometers (μm) thick.

In Example 18, the subject matter of any one or more of Examples 1-17 can optionally include the femtosecond laser including settings wherein a pulse duration is between 222-500 femtoseconds, a frequency is between 250-500 kHz, a power density is between 5.74×10^5 W/cm2-5.74×10^6 W/cm2, a femtosecond laser scan rate is between 200-2000 mm/sec, a spot overlap is between 40%-90%, and a number of passes is at least 25 passes.

In Example 19, the subject matter of any one or more of Examples 1-18 can optionally include the anode material being screen-printed on to both front and back sides of the substrate.

In Example 20, the subject matter of any one or more of Examples 1-19 can optionally include the sintered anode material being deposited in multiple layers having progressively smaller profiles.

In Example 21, subject matter (e.g., a system or apparatus) may optionally combine any portion or combination of any portion of any one or more of Examples 1-20 to comprise “means for” performing any portion of any one or more of the functions or methods of Examples 1-20, or at least one “non-transitory machine-readable medium” including instructions that, when performed by a machine, cause the machine to perform any portion of any one or more of the functions or methods of Examples 1-20.

This Summary is an overview of some of the teachings of the present application and not intended to be an exclusive or exhaustive treatment of the present subject matter. Further details about the present subject matter are found in the detailed description and appended claims. Other aspects of the invention will be apparent to persons skilled in the art upon reading and understanding the following detailed description and viewing the drawings that form a part thereof. The scope of the present invention is defined by the appended claims and their legal equivalents.

### BRIEF DESCRIPTION OF THE DRAWINGS

The drawings illustrate generally, by way of example, various embodiments discussed in the present document. The drawings are for illustrative purposes only and may not be to scale.

FIG. 1 shows a schematic representation of a medical system including a sintered capacitor, in accordance with one embodiment.

FIG. 2 shows an implanted medical system including a sintered capacitor, in accordance with one embodiment.

FIG. 3 shows a capacitor, in accordance with one embodiment.

FIG. 4 shows an exploded view of the capacitor, in accordance with one embodiment.

FIG. 5 shows a substrate sheet holding a plurality of anodes, in accordance with one embodiment.

FIG. 6 shows a schematic representation of a laser cutting process, in accordance with one embodiment.

FIG. 7 shows a top view of a sintered anode, in accordance with one embodiment.

FIG. 8 shows a cross-section view of a capacitor stack, in accordance with one embodiment.

FIG. 9 shows a cross-section view of a capacitor stack within a capacitor case, in accordance with one embodiment.

FIG. 10 shows a method of forming a capacitor, in accordance with one embodiment.

### DETAILED DESCRIPTION

The following detailed description of the present invention refers to subject matter in the accompanying drawings which show, by way of illustration, specific aspects, and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is, therefore, not to be taken in a limiting sense, and the scope is defined only by the appended claims, along with the full scope of legal equivalents to which such claims are entitled.

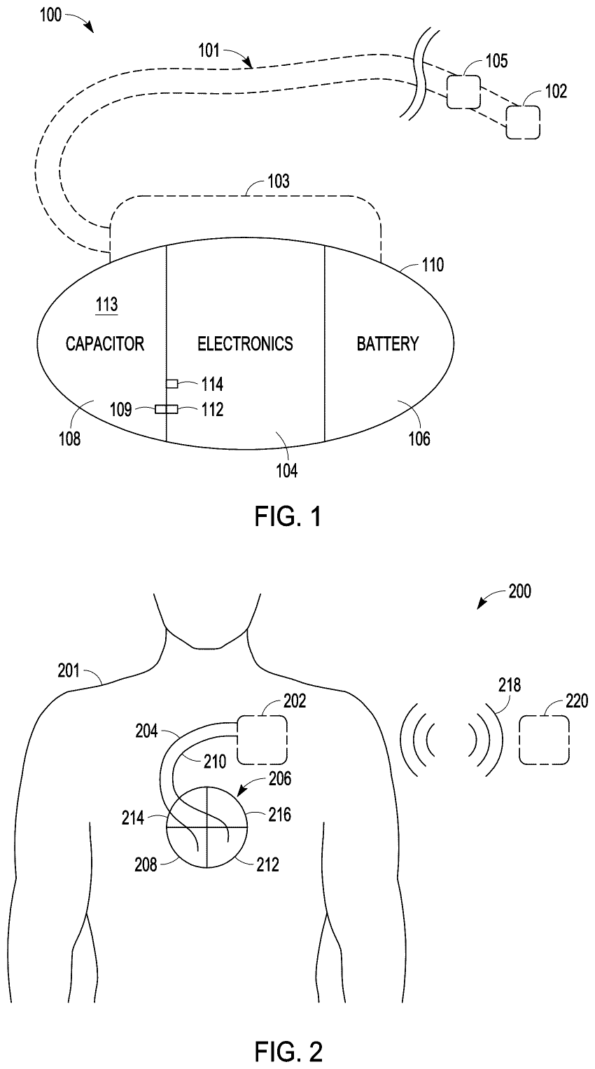

FIG. 1 is a schematic of a medical system 100 including a sintered capacitor, according to some embodiments. The medical system 100 represents any number of systems to provide therapeutic stimulus, such as to a heart. Examples of medical systems include, but are not limited to, implantable pacemakers, implantable defibrillators, implantable nerve stimulation devices and devices that provide stimulation from outside the body, including, but not limited to, external defibrillators.

Electronics 104 are to monitor the patient, such as by monitoring a sensor 105, and to monitor and control activity within the system 100. In some examples, the electronics 104 are to monitor a patient, diagnose a condition to be treated such as an arrhythmia, and control delivery of a stimulation pulse of energy to the patient. The electronics 104 can be powered wirelessly using an inductor. Alternatively, the electronics 104 can be powered by a battery 106. In some examples, electronics 104 are to direct small therapeutic bursts of energy to a patient from the battery 106.

For therapies, such as defibrillation, which use energy discharge rates exceeding what battery 106 is able to provide, a capacitor 108 is used. Energy from the battery 106 is controlled by the electronics 104 to charge the capacitor 108. The capacitor 108 is controlled by the electronics 104 to discharge to a patient to treat the patient. In some examples, the capacitor 108 completely discharges to a patient, and in additional examples, the capacitor is switched on to provide therapeutic energy and switched off to truncate therapy delivery.

Some examples of a medical system 100 include an optional lead system 101. In certain instances, after implantation, the lead system 101 or a portion of the lead system 101 is in electrical communication with tissue to be stimulated. For example, some configurations of lead system 101 contact tissue with a stimulation electrode 102. The lead system 101 couples to other portions of the system 100 via a connection in a header 103. Examples of the lead system 101 use different numbers of stimulation electrodes and/or sensors in accordance with the needs of the therapy to be performed.

Additional examples function without a lead 101. Leadless examples can be positioned in contact with the tissue to be stimulated or can be positioned proximal to tissue to shock the tissue to be stimulated through intermediary tissue. Leadless examples can be easier to implant and can be less expensive as they do not require the additional lead components. The housing 110 can be used as an electrode in leadless configurations.

In certain embodiments, the electronics 104 include an electronic cardiac rhythm management circuit coupled to the battery 106 and the capacitor 108 to discharge the capacitor 108 to provide a therapeutic pulse, such as a defibrillation pulse. In some examples, the system 100 includes an anode and a cathode sized to deliver a pulse of at least approximately 40 joules. Other configurations can deliver larger amounts of energy. Some configurations deliver less energy, for example at least 36 joules. In some examples, the energy level is predetermined to achieve a delivered energy level mandated by a governing body or standard associated with a geographic region, such as a European country. In an additional embodiment, the anode and cathode are sized to deliver a defibrillation pulse of at least approximately 80 joules. In some examples, this is the energy level is predetermined to achieve an energy level mandated by a governing body of another region, such as the United States. In some examples, electronics 104 are to control discharge of a defibrillation pulse so that the medical system 100 delivers only the energy mandated by the region in which the system 100 is used.

In certain examples, the capacitor 108 includes a capacitor case 113 sealed to retain electrolyte. In some examples, the capacitor case 113 is welded. In some instances, the capacitor case 113 is hermetically sealed. In additional examples, the capacitor case 113 is sealed to retain electrolyte, but is sealed with a seal to allow flow of other matter, such as gaseous diatomic hydrogen or a helium molecule. Some of these examples use an epoxy seal. The capacitor further includes a conductor 109 coupled to one of the electrodes of the capacitor 108. The conductor 109 sealingly extends through the capacitor case to a first terminal 112 disposed on an exterior of the capacitor case 113. A second terminal 114 can be disposed on the exterior of the capacitor case 113 and in electrical communication with the other electrode of the capacitor 108. The first terminal 112 and the second terminal 114 are electrically isolated from one another.

A hermetically sealed device housing 110 is used to house components, such as the battery 106, the electronics 104, and the capacitor 108. Hermeticity is provided by welding components into the hermetically sealed device housing 110, in some examples. Other examples bond portions of the housing 110 together with an adhesive such as a resin based adhesive such as epoxy. Accordingly, some examples of the housing 110 include an epoxy sealed seam or port. Several materials can be used to form housing 110, including, but not limited to, titanium, stainless steel, nickel, a polymeric material, or combinations of these materials. In various examples, the housing 110 and the case 113 are biocompatible.

The capacitor 108 is improved by the present electrode technology in part because it can be made with less expense and a variety of shapes and configurations. The improvement provided by these electrodes is pertinent to any application where high-energy, high-voltage, or space-efficient capacitors are desirable, including, but not limited to, capacitors used for medical devices. The present subject matter extends to energy storage devices that benefit from high surface area sintered electrodes including, but not limited to, aluminum.

FIG. 2 illustrates an implanted medical system 200, implanted in a patient 201, and including a sintered capacitor, according to some embodiments. The system includes a cardiac rhythm management device 202 coupled to a first lead 204 to extend through the heart 206 to the right ventricle 208 to stimulate at least the right ventricle 208. The system also includes a second lead 210 to extend through the heart 206 to the left ventricle 212. In various embodiments, one or both of the first lead 204 and the second lead 210 include electrodes to sense intrinsic heart signals and to stimulate the heart. The first lead 204 is in direct contact (e.g., touching) with the right atrium 214 and the right ventricle 208 to sense and/or stimulate both those tissue regions. The second lead 210 is in direct contact with the left atrium 216 and the left ventricle 212 to sense and/or stimulate both those tissue regions. The cardiac rhythm management device 202 uses the lead electrodes to deliver energy to the heart, either between electrodes on the leads or between one or more lead electrodes and the cardiac rhythm management device 202. Some embodiments can include epicardially or subcutaneously placed leads. In some examples, the cardiac rhythm management device 202 is programmable and wirelessly 218 communicates programming information with a programmer 220. In some examples, the programmer 220 wirelessly 218 charges an energy storage device of the cardiac rhythm management device 202.

As noted above, some medical devices utilize aluminum electrolytic high voltage capacitors to provide energy for arrhythmia therapy. For example, sintered aluminum anode electrode technology can be utilized for its high specific surface area, low resistance, and long term performance stability. Anodes, cathodes, and separators can be stacked in an alternating pattern to produce the electrode stack, which is ultimately placed into a capacitor case and filled with electrolyte.

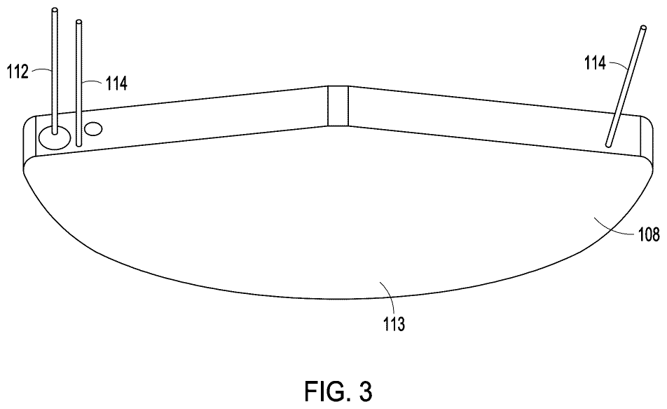

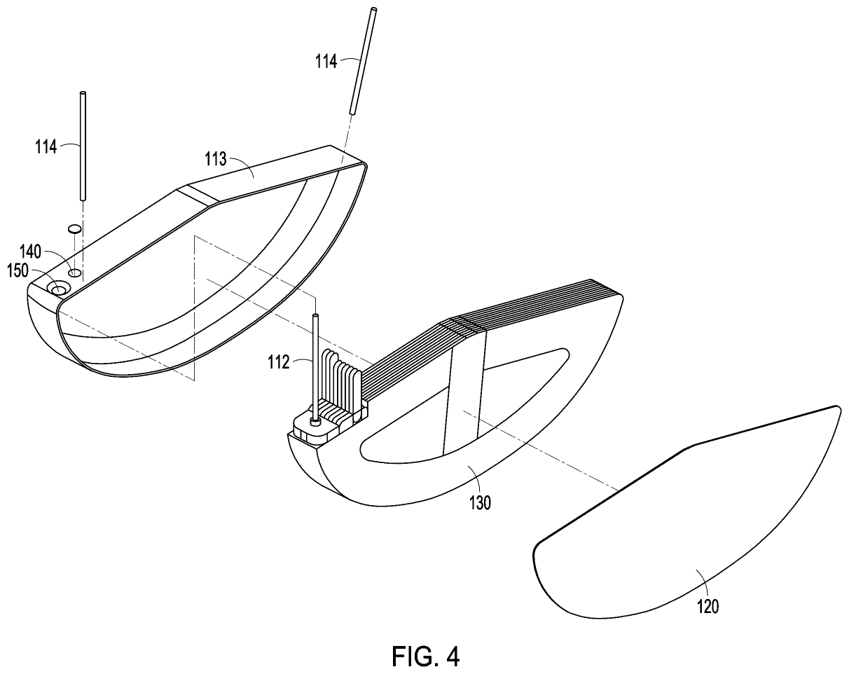

FIG. 3 shows a capacitor 108, in accordance with one embodiment, and FIG. 4 shows an exploded view of the capacitor 108, in accordance with one embodiment.

Here, the capacitor 108 includes the capacitor case 113. A capacitor stack 130 which includes a stack of alternating anodes and cathodes is placed in the case 113. The capacitor case 113 includes a lid 120 to cover the stack and enclose the stack 130 within the case 113. One or more terminals 114 are connected to the case 113 and act as terminals for the cathodes of the capacitor stack 130. The anodes in the stack 130 are couple to a terminal 112 which is electrically insulated from the case 113 and from the terminals 114 and extends through a feedthrough 150 in the case 113 and is disposed on an exterior of the capacitor case 113. A hole 140 can be incorporated in the case 113 to allow for adding electrolyte within the case 113. After assembly, the case 113 is sealed to retain the electrolyte.

Here, the capacitor case 113 has a same shape as a shape of the capacitor stack 130 comprising the alternating anodes and cathodes.

One problem that can arise during capacitor manufacturing is conductive aluminum debris (i.e. conductive shards) from the assembly process. For example these can be caused because mechanical die punching is commonly used to excise the anode aluminum electrode from a larger shape, sheet, roll, etc. Punching through the sintered aluminum creates aluminum debris (shards). Moreover the amount of debris created is proportional to the electrode thickness. This debris may connect and short anode and cathode layers within the capacitor.

Another issue with die punching through the sintered aluminum is that punching through the anode electrode exposes raw aluminum to the electrolyte solution within the final capacitor, with the amount of raw aluminum exposed being proportional to the excised thickness. This exposed raw aluminum requires proportionally greater capacitor manufacturing processing to form an anodic oxide on the raw aluminum. Moreover, the anodic oxide formed during capacitor manufacturing can result in inferior long term capacitor charge time stability performance. The present capacitor system has been developed to address these problems.

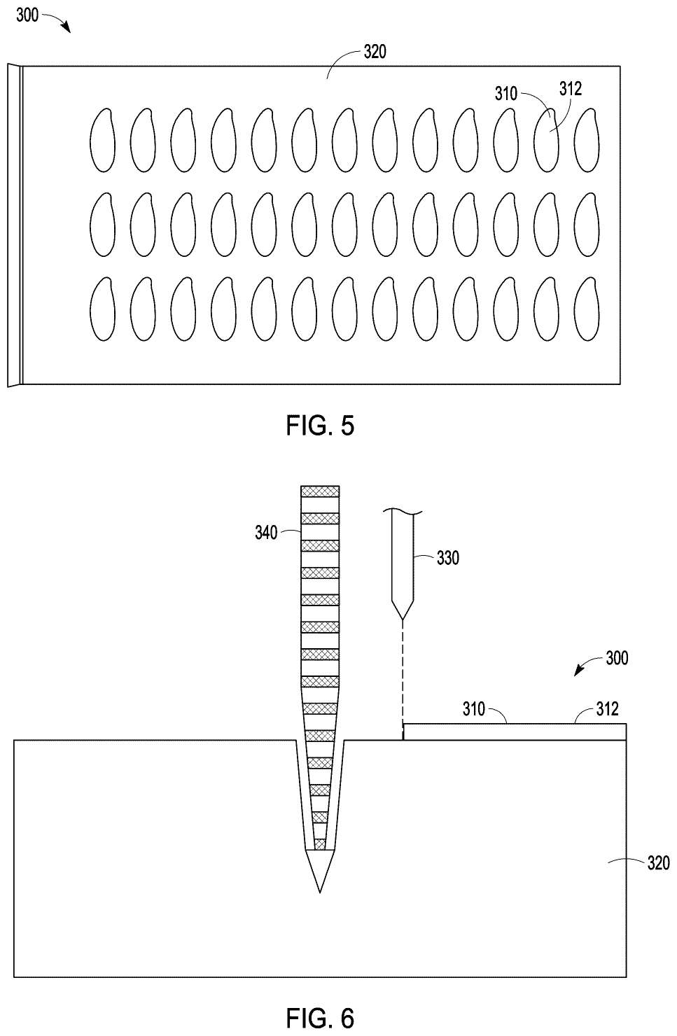

FIG. 5 shows an anode assembly sheet 300 holding a plurality of anodes 310, in accordance with one embodiment. Here, the entire assembly sheet 300 can include a plurality of sintered anodes 310 comprising sintered aluminum anode material 312 sintered onto a substrate 320. In this example the substrate 320 can be an aluminum foil substrate.

The sintered aluminum anode material 312 can be printed onto the substrate 320 in the final shape and form factor of the final anode. In this example, the anode material 312 is printed on to both sides of the substrate so that the other side of the substrate 320 (not seen in FIG. 5) includes a mirror image of the first side of the substrate 320. Multiple electrodes 310 can be include on the substrate 310, wherein each of the multiple electrodes 310 are then cut out of the substrate separately. This allows for a large batch process.

Accordingly, the present system uses a print-to-shape electrode. This allows for sintered aluminum electrodes to be manufactured in any unique, complex, final capacitor shape form factor (rather than the shapes used to promote die punching) onto a solid, thin aluminum substrate. In this example, the sintered aluminum anode material 312 can printed in multiple layers, front and back of substrate 320, but the sintered aluminum can also be deposited via various applications.

As will be further detailed below, the abovementioned anode material deposition process of printing the anodes in their final shape onto the substrate allows subsequent excise of the anodes from the substrate sheet 300 leaving the deposited porous sintered electrode material 312 untouched and therefore unaffected by the excise process. This means that there will be less conductive aluminum debris (i.e. conductive shards) from the assembly process since a mechanical die is not utilized. Further, by cutting only the substrate 320, no sintered material 312 is cut, which would expose raw aluminum to the electrolyte solution within the final capacitor. The present system negates that possibility.

FIG. 6 shows a schematic representation of a laser cutting process, in accordance with one embodiment.

In this example, after the assembly sheet 300 is formed, the anodes 310 are cut from the substrate 320 by excising each of the sintered anodes 310 from the substrate 320 by cutting through the substrate 320 around a periphery of the sintered anode 310, without cutting the sintered material 312.

Here, the anodes 310 are excised from the substrate 320 using a short-pulsed laser with multiple passes. Most lasers produce a heat-affected zone (HAZ) resulting in a recast layer. Moreover, the heat can lead to stressed metal, which can cause capacitor performance degradation and the heat can lead to non-ideal oxide phase deposit on the Al material. Accordingly, in one example, the present system can excise each of the anodes 310 from the substrate 320 using a femtosecond laser 340 to cut through the substrate 320. Using a femtosecond laser 340 reduces the heat-affected zone of the cut area. The femtosecond laser 340 results in a ‘cold’, smooth cut with no recast layer, promoting improved performance.

By cutting though the substrate 320 only, the femtosecond laser system minimizes any heat-affected zone, which limits barrier oxide phase. In other words, if the sintered material 312 were cut through, the cut edge of the sintered anode would need to be re-constituted. Moreover, using the femtosecond laser 340 results in less debris than punching the anode out of a rectangular anode card, as was done in the past. Laser excising also leaves the bulk sintered aluminum material 312 untouched which results in less anodic oxide formed during manufacturing and improves long term capacitor performance.

In one example, the substrate 320 can include an aluminum foil substrate about 30 micrometers (μm) thick. The sintered anode material 312 can have any thickness or shape, which does not matter, since only the substrate 320 is being cut through. In other examples, the substrate 320 can have a thickness between about 25 μm-35 μm.

In one example, to cut through the aluminum substrate 320, the femtosecond laser 340 can have settings of a pulse duration of 222 femtoseconds at a frequency of 250 kHz, and a power density of 5.74×10^5 W/cm². Further, the femtosecond laser scan rate can be 1,000 mm/sec, with a spot overlap of 80%, and a number of passes per electrode cut being 35 passes. Using multiple passes to cut through the substrate 320 reduces the heat-affected zone. In other examples, the femtosecond laser can have settings in any one or more of the following ranges where the pulse duration can be between 222-500 femtoseconds, the frequency can be between 250-500 kHz, the power density can be between 5.74×10^5 W/cm²-5.74×10^6 W/cm², the scan rate can be between 200-2000 mm/sec, the spot overlap can be between 40%-90%, and the number of passes can be at least 25 passes or more.

In one example, a vision system 330 can include one or more vision sensors to control the femtosecond laser cutting path. The vision system 330 can be configured to accurately follow the periphery of the electrode 310 outline. The vision system 330 can feed the location information to a femtosecond laser controller which can then position the laser 340 accordingly. Using the vision system 330 allows for easily changing the shapes of the anodes, if needed.

Accordingly, the laser cutting process can include a process in which the individual sintered electrode anodes 310 are laser excised from the batch substrate sheet 300. The laser excise can be performed using a short-pulsed laser. The laser excise process can be integrated into an automated process/equipment, using vision to detect the edge periphery of the sintered anode coupons and detect dynamic excise paths based on the anode shape, size, and dimensions, thus providing process flexibility not available with die punching.

The laser path cuts around the bulk sintered portion of each anode 310, only excising through the solid base substrate 320, this enables identical processing regardless of the sintered electrode thickness, porosity, etc. since the substrate 320 is the same thickness throughout the sheet 300 and between product types.

Moreover, excising through a thin base aluminum substrate (vs. the porous bulk electrode) promotes a minimized heat affected zone, which limits barrier oxide phase from forming on the aluminum material, and limits recast layers re-depositing onto the material; all of which can result in diminished capacitor performance. The HAZ is further reduced by implementing multiple laser excise passes, over the same path, to remove small amounts of substrate material each pass.

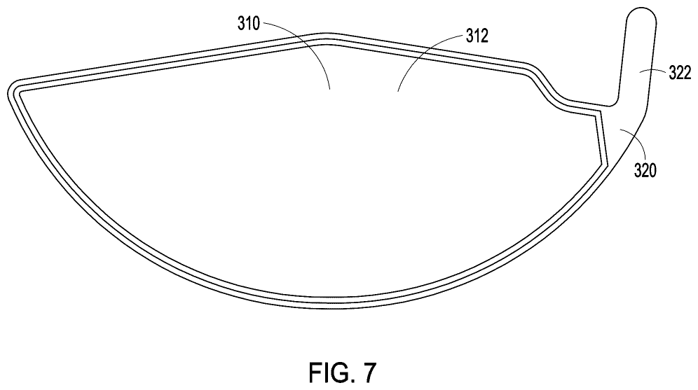

FIG. 7 shows a top view of an excised sintered anode 310, in accordance with one embodiment. In this example, after being excised, the sintered anode 310 includes the sintered material 312 on top (and bottom, not shown) of the substrate 320. In this example, a tab 322 is formed during the laser cutting process in the substrate 320. The tab 322 will later be coupled to a connector and then to the terminal 112 (see FIG. 4).

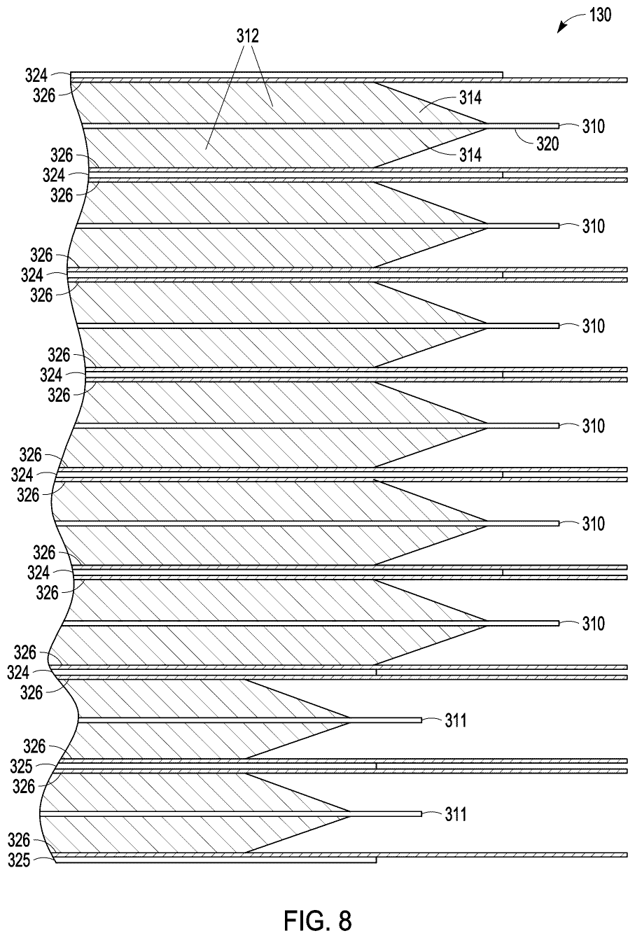

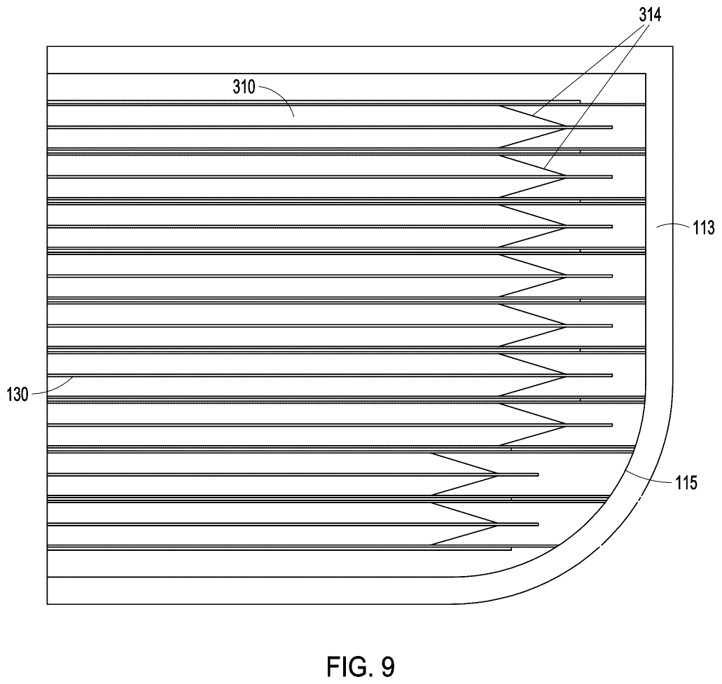

FIG. 8 shows a cross-section view of a capacitor stack 130, in accordance with one embodiment, and FIG. 9 shows a cross-section view of the capacitor stack 130 within the capacitor case 113, in accordance with one embodiment.

The capacitor stack 130 can include alternating layers including a plurality of cathodes 324 and anodes 310 with a separator 326 between each anode 310 and each cathode 324. In one embodiment, the cathodes 324 can include sintered cathodes.

As noted above, each sintered anode 310 includes a sintered material 312 on both sides of the substrate 320 and an edge of the sintered material 312 on both sides of the substrate 320 can have a tapered shape in a cross-sectional profile, defining a tapered end 314. For example, the sintered material 312 can be deposited onto the substrate 320 per the final unique capacitor design shape and deposited in progressively smaller profile layers to best control shape profile tolerance.

For example, the sintered material 312 can be deposited in multiple layers having progressively smaller profiles such that a cross-section profile of the sintered material 312 includes the tapered end 314. The tapered shape of the tapered end 314 helps for edge quality control of the capacitor stack 130 because of tolerances in the printing process where each anode 310 might have a slightly different size. Thus, the tapered shape of each of the sintered materials 312 defines a V-shape defined by the sintered material 312 on both sides of the substrate 320. The tapered edges of each of the anodes 310 allow for better profile in the printed anodes because of allowing for more tolerance than if the anodes were printed with a square edge, since variations in overall size can be accounted for.

Moreover, the capacitor stack 130 can include the plurality of sintered anodes 310 formed in the stack 130 with at least one of the sintered anodes 311 having a smaller shape than other of the plurality of a sintered anodes 310 so a side view profile of the stack matches a curve 115 in the capacitor case 113. Again, the quality of the edges of the anodes is improved because the tapered end allows for tolerances to be compensated for, especially at corners. For example, the tapered ends 314 allows for better edge control, especially where the stack 130 meets the curved edge surface 115 of the capacitor case 113.

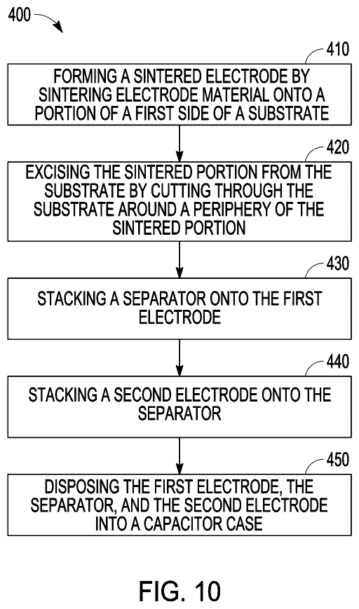

FIG. 10 shows a method (400) of forming a capacitor, in accordance with one embodiment. The method (400) can include forming a sintered electrode (410) by sintering electrode material onto a portion of a first side of a substrate; excising the sintered portion (420) from the substrate by cutting through the substrate around a periphery of the sintered portion, without cutting the sintered portion, wherein excising includes using a femtosecond laser to cut through the substrate; stacking a separator onto the first electrode (430); stacking a second electrode onto the separator (440); and disposing the first electrode, the separator, and the second electrode into a capacitor case (450).

The method can further include electrically coupling the first electrode to a first terminal disposed on an exterior of the capacitor case; electrically coupling the second electrode to a second terminal disposed on the exterior of the capacitor case, the second terminal electrically isolated from the first terminal; filling the capacitor case with an electrolyte; and sealing the electrolyte in the capacitor case.

As noted, the first electrode can include a sintered aluminum anode sintered onto an aluminum foil. The second electrode can include a sintered cathode. The sintered anode can be printed onto the aluminum foil in its final shape, thus when excising the anode material from the foil, the femtosecond laser just follows along a periphery of the anode and cuts the foil, leaving the anode material itself untouched.

The anode material can be screen-printed on to both front and back sides of the substrate. There can be multiple anodes on each substrate sheet. The sintered anode material can be deposited in multiple layers having progressively smaller profiles. This results in the anode having a tapered profile. As noted, this helps for any tolerance issues when assembling a plurality of anodes into a stack, relative to using a square edge.

In summary, the present system results in conductive debris minimization during formation of the sintered anodes. For example, there can be over a 90% reduction in aluminum debris generated, as compared to die punching through sintered aluminum material.

Moreover, regarding capacitor performance, the system improves long term charge times. Leaving the bulk sintered electrode untouched results in less anodic oxide formed during capacitor manufacturing and improves long term capacitor performance.

Moreover, the system enables excising of thicker sintered aluminum electrodes, or those with non-uniform thicknesses, due to constant thickness of the substrate, which is the only material being cut. The vision/laser technology enables fast, real-time excise path changes based on vision detected shapes.

This application is intended to cover adaptations or variations of the present subject matter. It is to be understood that the above description is intended to be illustrative and not restrictive. The scope of the present subject matter should be determined with reference to the appended claims, along with the full scope of legal equivalents to which such claims are entitled.

What is claimed is:

1. A method of constructing a capacitor, comprising:
forming a sintered electrode by sintering electrode material onto a portion of a first side of a substrate; and
excising the sintered portion from the substrate by cutting through the substrate around a periphery of the sintered portion, without cutting the sintered portion, wherein excising includes using a femtosecond laser to cut through the substrate.

2. The method of claim 1, wherein the substrate is an aluminum foil substrate about 25-35 micrometers (μm) thick.

3. The method of claim 1, wherein the femtosecond laser includes settings wherein a pulse duration is between 222-500 femtoseconds, a frequency is between 250-500 kHz, and a power density is between 5.74×10^5 W/cm²-5.74×10^6W/cm².

4. The method of claim 3, wherein the femtosecond laser settings further include wherein a scan rate is between 200-2000 mm/sec, a spot overlap is between 40%-90%, and a number of passes is at least 25 passes.

5. The method of claim 1, wherein a vision system is used to control a femtosecond laser path during a cutting process.

6. The method of claim 1, wherein forming the sintered electrode includes printing the sintered material onto the substrate into a final capacitor shape form-factor.

7. The method of claim 6, wherein the electrode material is printed on both a first side and a second side of the substrate.

8. The method of claim 7, wherein the sintered material is deposited in multiple layers having progressively smaller profiles such that a cross-section profile of the sintered material includes a tapered end.

9. The method of claim 1, further comprising:
stacking a separator onto the first electrode;
stacking a second electrode onto the separator;
disposing the first electrode, the separator, and the second electrode into a capacitor case;
electrically coupling the first electrode to a first terminal disposed on an exterior of the capacitor case;
electrically coupling the second electrode to a second terminal disposed on the exterior of the capacitor case, the second terminal electrically isolated from the first terminal;
filling the capacitor case with an electrolyte; and
sealing the electrolyte in the capacitor case.

10. The method of claim 1, further comprising forming multiple electrodes on the substrate, wherein each of the multiple electrodes are then cut out of the substrate separately.

11. A capacitor comprising:
a capacitor case sealed to retain electrolyte;
a sintered anode, wherein the sintered anode includes a sintered material on both sides of a substrate and wherein an edge of the sintered material on both sides of the substrate has a tapered shape in a cross-sectional profile;
a cathode disposed in the capacitor case;
a separator between the sintered anode and the cathode;
a conductor coupled to the sintered anode, the conductor coupled to a terminal sealingly extending through and disposed on an exterior of the capacitor case; and
a second terminal disposed on the exterior of the capacitor case and in electrical communication with the cathode, with the terminal and the second terminal electrically isolated from one another.

12. The capacitor of claim 11, wherein the capacitor case has a same shape as a shape of the anode and the cathode.

13. The capacitor of claim 11, further including a plurality of sintered anodes formed in a stack with at least one of the sintered anodes having a smaller shape than other of the plurality of a sintered anodes so a side view profile of the stack matches a curve in the capacitor case.

14. The capacitor of claim 13, wherein the tapered shape of each of the sintered material defines a V-shape defined by the sintered material on both sides of the substrate.

15. The capacitor of claim 11, wherein the cathodes include sintered cathodes.

16. A capacitor comprising:
a sintered anode formed by sintering material onto a portion of a side of an aluminum substrate and excising the sintered portion from the substrate by cutting through the aluminum substrate around a periphery of the sintered portion, without cutting the sintered portion, wherein excising includes using a femtosecond laser to cut through the aluminum substrate;
stacking a separator onto the sintered anode;
stacking a cathode onto the separator;
disposing the anode, the separator, the cathode into a capacitor case;
electrically coupling the anode to a first terminal disposed on an exterior of the capacitor case;
electrically coupling the cathode to a second terminal disposed on the exterior of the capacitor case, the second terminal electrically isolated from the first terminal;
filling the capacitor case with an electrolyte; and
sealing the electrolyte in the capacitor case.

17. The capacitor of claim 16, wherein the aluminum substrate is about 25-35 micrometers (μm) thick.

18. The capacitor of claim 16, wherein the femtosecond laser includes settings wherein a pulse duration is between 222-500 femtoseconds, a frequency is between 250-500 kHz, a power density is between 5.74×10^5 W/cm²-5.74×10^6 W/cm², a femtosecond laser scan rate is between 200-2000 mm/sec, a spot overlap is between 40%-90%, and a number of passes is at least 25 passes.

19. The capacitor of claim 16, wherein the anode material is screen-printed on to both front and back sides of the substrate.

20. The capacitor of claim 19, wherein the sintered anode material is deposited in multiple layers having progressively smaller profiles.
